(19) United States
(12) Patent Application Publication
(10) Pub. No.: US 2009/0080307 A1
(43) Pub. Date: Mar. 26, 2009

(54) Method of manufacturing optical head including the step of adjusting parallelism of light beam

(75) Inventors: Kazunori Hirose, Hong Kong (CN); Jun Ming Bai, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE MAGNETICS (H.K.) Ltd., Hong Kong (CN)

(21) Appl. No.: 12/230,651

(22) Filed: Sep. 3, 2008

(30) Foreign Application Priority Data
Sep. 20, 2007 (CN) CN200710149880.9

(51) Int. Cl. G11B 7/00

(52) U.S. Cl. 369/53.25; G9B/7

(57) ABSTRACT

A method for manufacturing an optical head having a laser beam emitting device that emits a light beam of a predetermined wavelength, an objective lens that focuses the light beam on an optical recording medium and a parallelism adjusting lens that is disposed on an optical path between the laser beam emitting device and the objective lens, wherein the parallelism adjusting lens is configured to change parallelism of the laser beam, is disclosed. The method comprise the step of adjusting the parallelism of the light beam that has passed through the parallelism adjusting lens by adjusting a distance between the laser beam emitting device and the parallelism adjusting lens while causing the laser beam emitting device to emit the light beam and causing the light beam to pass through the parallelism adjusting lens.

The present application is based on, and claims priority from, Chinese Patent Application No. 200710149880.9, filed on Sep. 20, 2007, the disclosure of which is hereby incorporated by reference herein in its entirety.

### BACKGROUND OF THE INVENTION

1. Field of the Invention

The present invention relates to a method for manufacturing an optical head, and more particularly to a method for adjusting the spherical aberration of an optical head.

2. Description of the Related Art

The construction of an optical head having a semiconductor laser that emits a light beam of a predetermined wavelength, an objective lens and a collimating lens disposed on the optical path between the semiconductor laser and the objective lens is generally known. A light beam emitted from a semiconductor laser travels along an optical axis in the form of a divergent beam, the divergence of which is then converted (usually to a substantially parallel beam) by a collimating lens, and the light beam is focused on a predetermined position of an optical recording medium by an objective lens.

Recently, high recording density optical discs, such as HD DVD (High Definition Digital Versatile Disc) and Blu-ray Disc (registered trademark), have been spreading in the market. In this specification, next-generation media, such as DVD-ROMs and DVD-R/RWs, and other media having a similar construction and a storage capacity are called “next-generation DVDs.” An optical head for recording digital information to a next-generation DVD or for reproducing digital information from a next-generation DVD generally uses a light source made of a GaN-based semiconductor laser that emits a light beam having a short wavelength of about 405 nm. In general, a light beam having such a wavelength largely varies in the refractive index depending on the wavelength, and therefore, a variation in the wavelength of a light beam emitted from the light source tends to increase the spherical aberration of the optical head.

In recent years, what is called a multilayer disc, in which two or more information recording layers are provided in order to increase the recording capacity per optical disc, has also become common. Information recording layers in a multilayer disc are different from each other in the distance between the light incident plane and the information recording layer, thereby requiring correction of the spherical aberration of the optical head according to the information recording layer that is selected.

Thus, conventional optical heads are provided with a set of lenses for correcting spherical aberration disposed on the optical path at an upstream position or at a downstream position relative to the collimating lens. The conventional optical heads also has a beam expander mechanism that shifts some of the lenses in the optical axis direction (refer to Japanese Patent Laid-Open Publication No. 266511/93).

Also, other conventional optical heads are provided with a liquid crystal element disposed on an optical path thereof. The liquid crystal element changes its refractive index under an application of a voltage thereto, causing an appropriate phase difference to a light beam that passes therethrough to correct the spherical aberration (refer to Japanese Patent Laid-Open Publication No. 128785/97).

The technique to provide a beam expander mechanism causes an increase in the size of the optical head. This technique also has large disadvantages, such as an increase in cost caused by the additional shift mechanism and by the requirement for strict tolerance in assembling.

The technique to provide a liquid crystal element can avoid the above-mentioned disadvantage and is highly reliability because liquid crystal element can correct the spherical aberration by itself. However, a liquid crystal element divides a light beam into a plurality of subsections and changes the phase of the light beam in each subsection, thereby making the corrected wavefront discontinuous at the boundaries of the subsections. Furthermore, each subsection is subjected to a constant phase shift although the phase is continuously distributed. This causes a variation in the phase within each subsection and theoretically generates portions that undergo insufficient correction and portions that undergo excessive correction. Since the phase shift is proportional to the magnitude of the spherical aberration, large spherical aberration causes locally large phase shift, thereby increasing the aberration of wavefront as a whole and degrading the performance of the optical head.

### SUMMARY OF THE INVENTION

The object of the present invention is to provide a method for manufacturing an optical head that is capable of correcting the spherical aberration in a simple manner that does not require a complicated construction of the optical head.

According to an embodiment of the present invention, a method for manufacturing an optical head having a laser beam emitting device that emits a light beam of a predetermined wavelength, an objective lens that focuses the light beam on an optical recording medium and a parallelism adjusting lens that is disposed on an optical path between the laser beam emitting device and the objective lens, wherein the parallelism adjusting lens is configured to change parallelism of the laser beam, is disclosed. The method comprise the step of adjusting the parallelism of the light beam that has passed through the parallelism adjusting lens by adjusting a distance between the laser beam emitting device and the parallelism adjusting lens while causing the laser beam emitting device to emit the light beam and causing the light beam to pass through the parallelism adjusting lens.

A light beam that is emitted from the laser beam emitting device is adjusted by a parallelism adjusting lens, which is a lens that adjusts parallelism of a laser beam, such that it has a predetermined parallelism. The adjusted light beam is then focused on the predetermined position of an optical recording medium by the objective lens. In this specification, “parallelism” means the degree to which the light beam is divergent, convergent or parallel, i.e., the inclination of the outer periphery of the light beam relative to the optical axis. The state in which the section of a light beam decreases as a light beam travels toward an optical recording medium is “convergent.” The state in which the section of a light beam increases as a light beam travels toward an optical recording medium is “divergent.” The state in which the section of a light beam is kept constant as a light beam travels toward an optical recording medium is “parallel.”

As a result of the investigation performed by the inventors, it was found that the spherical aberration in the optical system of an optical head is partly caused by manufacturing errors associated with an objective lens and a collimating lens. Also, it was found that another cause for the spherical aberration is that the distance between the collimating lens and the laser beam emitting device is shifted from the design distance due to manufacturing errors and assembling errors of the optical elements. This is because a shift in the distance between the collimating lens and the laser beam emitting device makes the incident angle of the light beam vary depending on the incident positions on the lens at which the light beam is incident on the collimating lens and, therefore, makes the convergent point of the light beam vary depending on the incident positions, causing spherical aberration. Furthermore, a light beam having a wavelength of about 405 nm shows a large variation in the refractive index. Therefore, variation in the wavelength of a light beam emitted from a light source tends to increase the spherical aberration of an optical head. Incidentally, the spherical aberration caused by these reasons is closely related to parallelism of the laser beam emitted from the collimating lens. This means that the spherical aberration can be controlled by adjusting parallelism of the laser beam. Further, the inventors found that it is possible to adjust parallelism of the laser beam and hence to adjust the spherical aberration by adjusting the distance between the laser beam emitting device and the parallelism adjusting lens. According to the present invention, parallelism of the laser beam emitted from parallelism adjusting lens can be easily adjusted, and hence adjustment of the spherical aberration can be facilitated by using this method.

The above and other objects, features and advantages of the present invention will become apparent from the following description with reference to the accompanying drawings which illustrate examples of the present invention.

### BRIEF DESCRIPTION OF THE DRAWINGS

FIG. 1 is a schematic diagram showing the optical configuration of an optical head;

FIG. 2 is a conceptual diagram of an apparatus used for adjusting the spherical aberration of an optical head;

FIGS. 3A to 3C are schematic diagrams showing the relationship between the parallelism of the laser beam and the degree of convergence of the light beam that is incident on the autocollimator;

FIG. 4 is a schematic diagram showing the relationship between the spot size on the autocollimator and the spherical aberration of the optical head;

FIG. 5 is an exemplary diagram showing the relationship between the amount of shift in the position of semiconductor laser 4 in the direction of the optical axis and the spot size;

FIG. 6 is a schematic diagram showing the relationship between the spot size on the autocollimator and the spherical aberration of an optical head in the second embodiment;

FIG. 7 is an explanatory diagram showing a method for adjusting the distance between a semiconductor laser and a collimating lens by moving a dichroic prism; and

FIG. 8 is an explanatory diagram showing a method for adjusting the distance between a semiconductor laser and a collimating lens by moving a polarization beam splitter.

### DETAILED DESCRIPTION OF THE INVENTION

### First Embodiment

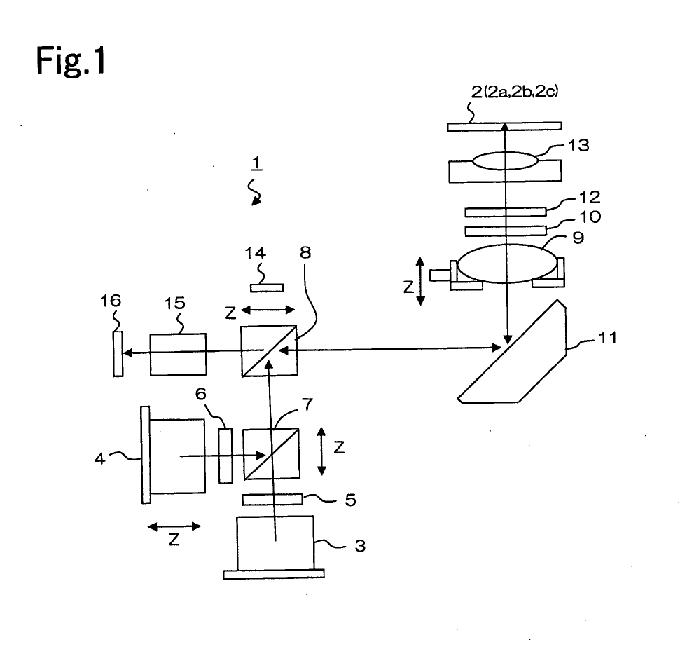

Embodiments of a method for manufacturing an optical head of the present invention will be described below with reference to the drawings. First, an optical head to which the present invention is applied will be summarized. FIG. 1 is a schematic diagram showing the optical configuration of an optical head. Optical head 1 is configured to record digital information to and to reproduce digital information from each of three kinds of optical recording media 2 (2a, 2b, 2c) having different physical track pitches.

First optical recording medium 2a is an optical recording medium, such as current DVD-ROMs and DVD±R/RWs and those having a similar construction and a storage capacity. Second optical recording medium 2b is an optical recording medium, such as CD (Compact Disc)-ROMs and CD-R/RWs and those having a similar construction and a storage capacity. Third optical recording medium 2c is the next-generation DVD-ROM mentioned above.

Optical head 1 has semiconductor lasers (laser beam emitting devices) 3, 4 which function as light sources that emit a light beam of a predetermined wavelength. Semiconductor laser 3 has a first light emitting part that emits a light beam having a wavelength of 650 nm (a first light beam), which is used to record data to and to reproduce data from current DVDs, and a second light emitting part that emits a light beam having a wavelength of 780 nm (a second light beam), which is used to record data to and to reproduce data from CDs. These light emitting parts are formed apart from each other at a predetermined distance and are housed in one package. On the other hand, semiconductor laser 4 emits a light beam having a wavelength of 405 nm (a third light beam), which is used to record data to and to reproduce data from the next-generation DVDs.

Semiconductor lasers 3, 4 are provided such that the optical axis of the first or the second light beam emitted from semiconductor laser 3 and the optical axis of the third light beam emitted from semiconductor laser 4 cross each other at right angles.

Diffraction grating 5 is disposed at a predetermined position on the light emitting side of semiconductor laser 3. Diffraction grating 5 has, on one surface thereof, a diffraction grating pattern that is optimized such that it divides the first or the second light beam emitted from semiconductor laser 3 into three light beams (a zero-order main beam and ±first-order sub beams, not shown). Diffraction grating 5 divides the first or the second light beam emitted from semiconductor laser 3 such that the ±first-order sub beams are focused on the front surface (the surface on which information is recorded) of optical recording medium 2 at positions that are symmetrical with respect to the position on which the main beam is focused and that are apart from each other at a predetermined distance with regard to the track width direction.

Similarly, diffraction grating 6 is disposed at a predetermined position on the light beam emitting side of semiconductor laser 4. Diffraction grating 6 has, on one surface thereof, a diffraction grating pattern that is optimized such that it divides the third beam emitted from semiconductor laser 4 into three light beams (a zero-order main beam and ±first-order sub beams, not shown). Diffraction grating 6 divides the third light beam emitted from semiconductor laser 4 such that the ±first-order sub beams are focused on the front surface (the surface on which information is recorded) of optical recording medium 2 at positions that are symmetrical with respect to the position on which the main beam is focused and that are apart from each other at a predetermined distance with regard to the track width direction.

Dichroic prism 7 having a generally cubic form is provided at the position at which the light beam emitted from semiconductor laser 3 and the light beam emitted from semiconductor laser 4 cross each other. Dichroic prism 7 allows the first and the second light beams to substantially totally pass therethrough, while causing the third light beam to be totally reflected.

The light beam that has passed through or that has been reflected by dichroic prism 7 is incident on polarization beam splitter 8. Approximately 90% of the light beam incident on polarization beam splitter 8 is reflected by polarization beam splitter 8 and is incident on intermediate mirror 11. The remaining light beam, i.e., approximately 10% of the light beam incident on polarization beam splitter 8, is incident on front monitoring photodetector 14. Front monitoring photodetector 14 measures the intensity of the first to third light beams emitted from semiconductor lasers 3, 4. The output of semiconductor lasers 3, 4 is adjusted based on the output of front monitoring photodetector 14.

The light beam incident on intermediate mirror 11 is reflected by intermediate mirror 11 and is incident on collimating lens 9. The light beam, which travels in the form of a divergent beam between semiconductor lasers 3, 4 and collimating lens 9, is converted into a generally parallel light beam by collimating lens 9. In other words, collimating lens 9 is a parallelism adjusting lens for changing the parallelism of a laser beam, that is disposed on the optical path between semiconductor lasers 3, 4 and objective lens 13.

The light beam that has passed through collimating lens 9 is incident on liquid crystal element 10. Liquid crystal element 10 is provided with transparent electrodes divided into subsections having predetermined shapes and being configured to exhibit the refractive index that varies according to an applied voltage. The transparent electrode is made of tin-doped indium oxide (ITO), tin oxide or the like. Application of a voltage to each subsection of liquid crystal element 10 causes a change in the refractive index to each subsection and gives an appropriate phase difference to the passing light beam, thereby correcting wavefront aberration that occurs at the focal point of optical recording medium 2. Examples of the wavefront aberration include wavefront aberration (mainly spherical aberration) that is associated with the thickness of optical recording medium 2 and wavefront aberration caused by the relative positional shift between objective lens 13 and liquid crystal element 10 that occurs due to eccentricity of optical recording medium 2.

The light beam that has passed through liquid crystal element 10 is incident on quarter-wave plate 12, which converts the linearly polarized main beam and ±first-order sub beams (hereinafter referred to as “advancing light beams”) into a circularly polarized light. The light beam that has passed through quarter-wave plate 12 is incident on objective lens 13, and is then focused on the information recording surface of optical recording medium 2. During a recording process, the focused light beam records information on a predetermined bit of the information recording surface and the recording process is completed.

In a reproducing process, the light beam focused on optical recording medium 2 is reflected by the information recording surface and further travels in the reverse direction. First, the light beam that is reflected by optical recording medium 2 is converted into a parallel beam by objective lens 13. Subsequently, the light beam is incident on quarter-wave plate 12 so that the light beam, which is a circularly polarized light, is converted into a linearly polarized light having a polarization plane that is perpendicular to the polarization plane of the advancing light beam. The light beam that has passed through quarter-wave plate 12 further passes through liquid crystal element 10. The light beam is then incident on collimating lens 9, at which the light beam is converted into a convergent beam. The light beam that has passed through collimating lens 9 is reflected by intermediate mirror 11 to be incident on polarizing beam splitter 8. Polarizing beam splitter 8 allows the light returning from collimating lens 9 to pass through the internal junction surface thereof so that the light is incident on anamorphic lens 15. Anamorphic lens 15 gives astigmatism to the light beam, which is incident thereon via polarizing beam splitter 8, in order to detect focal shift errors, and then focuses the light on light receiving element 16. Light receiving element 16 is divided into light receiving subsections, not shown. Each subsection independently converts the light beam it receives, and light receiving element 16 outputs an electric signal.

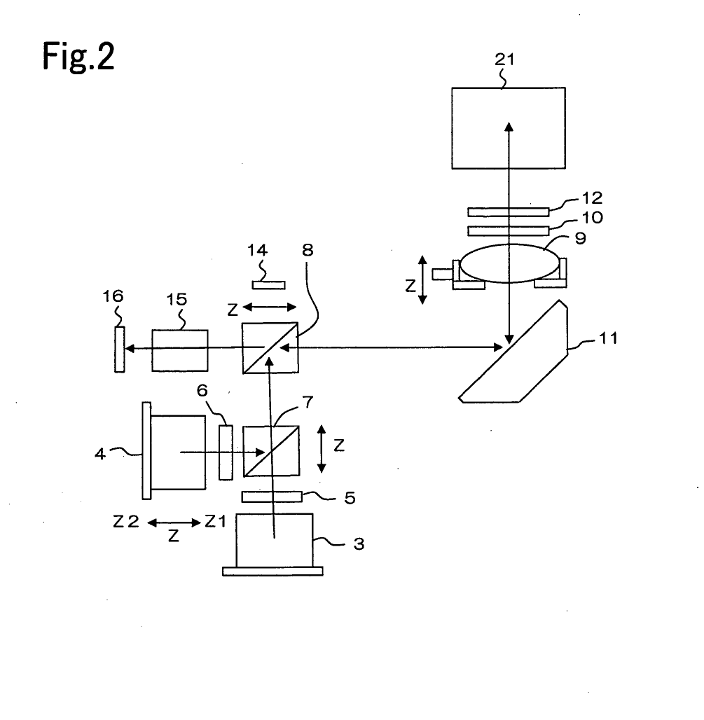

A method for manufacturing the above-mentioned optical head will be described below. The optical head can be manufactured by mounting each optical element mentioned above on a predetermined housing. Specifically, each element, except objective lens 13, is mounted on the housing first, as shown in FIG. 2. In the mounting step, semiconductor laser 4 is temporarily attached in order to allow a movement in direction Z of the optical axis. Next, autocollimator 21 is arranged in front of collimating lens 9. Autocollimator 21 is a relatively inexpensive device that is generally used for assembling an optical head. An autocollimator may be used to measure micro angles, but in this embodiment, this device is used to measure the parallelism of the laser beam that has passed through collimating lens 9.

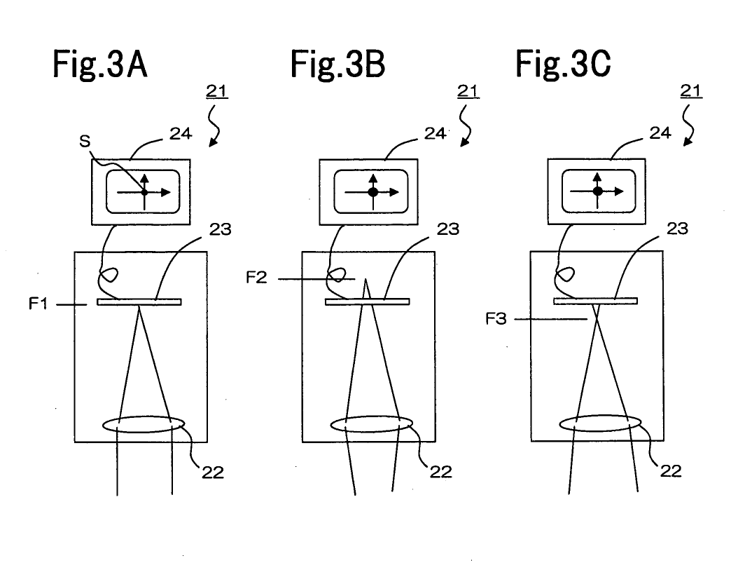

First, a description will be made about an adjustment method that is used when the degree of the spherical aberration of objective lens 13 is negligibly small. Autocollimator 21 is configured such that the optical beam is concentrated most intensively at a predetermined focal point when a parallel beam is incident thereon. FIGS. 3A to 3C are schematic diagrams showing the relationship between the parallelism of the laser beam and the degree of convergence of the light beam that is incident on the autocollimator. FIG. 3A shows the state when the light beam is a parallel beam. Autocollimator 21 has collimating lens 22, light-capturing element 23 and display 24. A light beam that is incident on autocollimator 21 is converted into a converging light by collimating lens 22 to be incident on light-capturing element 23. Beam-capturing element 23 is provided at a position that coincides with focal point F1 of a parallel beam that is incident on collimating lens 22. Therefore, the size of spot S of the light beam captured on light-capturing element 23 is minimized when a parallel beam is incident, and the spot diameter is minimized if the light beam has a circular section.

FIGS. 3B and 3C show the states when a divergent beam and a convergent beam are incident on the autocollimator, respectively. As shown in FIG. 3B, when a divergent beam is incident, the light beam that has passed through collimating lens 22 is focused at focal point F2 that is beyond light-capturing element 23. As shown in FIG. 3C, when a convergent beam is incident, the light beam that has passed through collimating lens 22 is focused at focal point F3 that does not reach as far as light-capturing element 23. In both cases, the spot size of the light beam captured by light-capturing element 23 is larger than the spot size in the case of FIG. 3A.

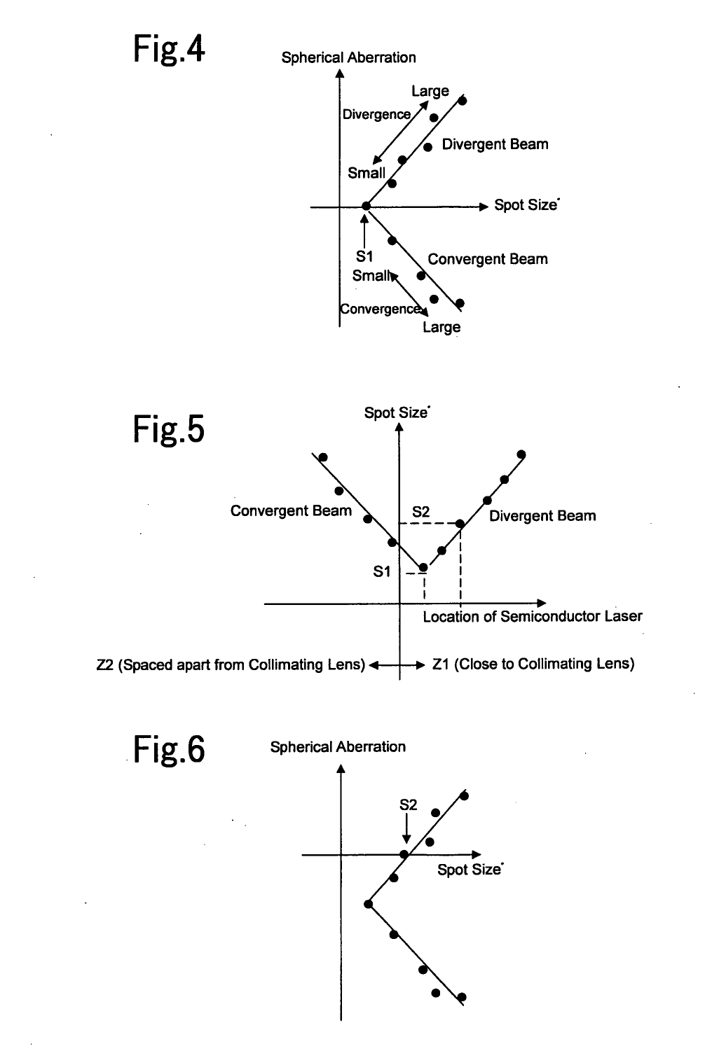

The above-mentioned relationship can be summarized in FIG. 4, which is a schematic diagram showing the relationship between the spot size on the autocollimator and the spherical aberration of the optical head. The spherical aberration of the optical head shown in the figure corresponds to the spherical aberration of an optical system generated between semiconductor laser 4 and objective lens 13. However, the spherical aberration shown in the figure can also be considered as the spherical aberration of the optical system generated between semiconductor laser 4 and collimating lens 9 because the spherical aberration of objective lens 13 is negligibly small. When a divergent beam is incident, the spherical aberration decreases in accordance with a reduction in the divergence, and the spherical aberration becomes zero when the incident beam becomes a parallel beam. The spherical aberration increases again when the incident beam becomes a convergent beam. Autocollimator 21 is adjusted, in advance, to indicate such characteristics. Therefore, it can be understood from the figure that a reduction in spherical aberration can be achieved by ensuring that the light beam emitted from collimating lens 9 is a parallel beam and that a parallel beam can be ensured by minimizing the spot size of the light beam. Thus, it is possible, in this embodiment, to detect parallelism of a laser beam by causing a light beam that has passed through collimating lens 9 to be incident on autocollimator 21 and by measuring the spot size of the light beam at focal point F1 of collimating lens 22.

In this embodiment, the distance between semiconductor laser 4 and collimating lens 9 is adjusted, and this makes it possible to convert the laser beam that has passed through collimating lens 9 into a parallel beam by adjusting the spot size. Specifically, a light beam is emitted from semiconductor laser 4 first, and the light beam then passes through collimating lens 9 while the parallelism thereof is adjusted by collimating lens 9. When the light beam is incident on autocollimator 21, a spot having a certain size is captured by light-capturing element 23 and displayed on display 24. Semiconductor laser 4 is moved in direction Z of the optical axis, i.e., in forward direction Z1 or in backward direction Z2 (see FIG. 2) by an operator while spot size S displayed on display 24 is checked. As a result, the spot size of the light beam displayed on display 24 is changed. The change in the spot size is caused by a change in the distance between semiconductor laser 4 and collimating lens 9 and by the resultant shift in the convergent point of the light beam.

FIG. 5 is an exemplary diagram showing the relationship between the amount of shift in the position of semiconductor laser 4 in the optical axis direction and the spot size. When semiconductor laser 4 is moved closer to collimating lens 9, i.e., in forward direction Z1 in FIG. 2, the light beam is reflected by collimating lens 9 with a small refraction angle (less bent by the refraction.) and the light beam that has passed through collimating lens 9 remains to be a divergent beam, without being converted into a parallel beam. Therefore, the spot size is also large. On the other hand, when semiconductor laser 4 is moved away from collimating lens 9, i.e., in backward direction Z2 in FIG. 2, the light beam that has passed through collimating lens 9, which is a parallel beam, is converted into a convergent beam, contrary to the above. In this way, it is possible to adjust the light beam such that the spot size is minimized (spot S1), i.e., such that the light beam that has passed through collimating lens 9 is converted into a parallel beam, by moving semiconductor laser 4 in direction Z of the optical axis while checking the spot size.

The above description is based on the assumption that the spherical aberration of objective lens 13 is negligibly small. Accordingly, an optical head having small spherical aberration can be fabricated by fixing semiconductor laser 4 at the present position in this state and thereafter by mounting objective lens 13 at a predetermined position. Needless to say, it is also possible to automatically move semiconductor laser 4 while checking the spot size by means of a computer instead of performing the operation by an operator.

As will be apparent from the above description, elements other than semiconductor laser 4 may be moved in direction Z of the optical axis, instead of semiconductor laser 4, because the spot size can be adjusted by changing the distance between semiconductor laser 4 and collimating lens 9. For example, collimating lens 9 may be moved in direction Z of the optical axis of the light beam. Also, other optical elements provided on the optical path between semiconductor laser 4 and collimating lens 9, such as dichroic prism 7 and polarization beam splitter 8, may be moved in direction Z of the optical axis of the light beam. When collimating lens 9 is moved, lens holder 17, which usually houses collimating lens 9, is preferably moved in direction Z of the optical axis. In another embodiment, it is also possible to move semiconductor laser 3, instead of semiconductor laser 4.

The present embodiment requires neither an additional lens nor a lens moving mechanism, thereby allowing a conventional optical head to be used as is. Therefore, an increase in the manufacturing cost can be limited. A device that measures the aberration of an entire optical head is a significantly large-scale and expensive, whereas this embodiment only requires measurement of parallelism of the laser beam emitted from a collimating lens. This allows a versatile autocollimator to be used, limiting an increase in the cost of the measuring device. Furthermore, the steps to be added are limited and the influence on manufacturing efficiency is also small.

### Second Embodiment

Next, a description will be made about an adjustment method used when the effect of the spherical aberration of objective lens 13 is not negligible. In this case, the spherical aberration of objective lens 13 is measured first. Next, based on the spherical aberration of objective lens 13 that was measured, a target parallelism of the light beam that has passed through collimating lens 9 is determined such that the spherical aberration in the optical system between semiconductor laser 4 and objective lens 13 is minimized. When the spherical aberration of objective lens 13 is large, it is required that a light beam having a target parallelism, which is determined, in advance, by taking into consideration the spherical aberration of objective lens 13, pass through collimating lens 9 so that the light beam is incident on a predetermined position of optical recording medium 2 with a minimum spot size.

FIG. 6 is a schematic diagram for explaining the concept of target parallelism that shows the relationship between the spot size on the autocollimator and the spherical aberration of the optical head. The spherical aberration of the optical head in the figure corresponds to the spherical aberration of the optical system generated between semiconductor laser 4 and objective lens 13. The target parallelism can be determined as the spot size of a light beam that is obtained when the light beam passing through collimating lens 9 is incident on autocollimator 21. As will be apparent from FIG. 6, the target spot size is spot size S2 obtained when the spherical aberration is zero. The state of the light beam that has passed through collimating lens 9 also depends on whether the light beam is a convergent beam or a divergent beam (a target beam state). Thus, the target parallelism is determined, in advance, as target spot size S2 and as the target beam state, based on the spherical aberration of objective lens 13. For example, when objective lens 13 has spherical aberration of a negative value, it is preferable that the light beam emitted from the collimating lens has spherical aberration of a positive value. Therefore, the target spot size is determined as spot size S2 in FIG. 5 and the target beam state is determined as a divergent beam. Accordingly, a light beam that has passed through collimating lens 9 is usually not a parallel beam, and the spot size is not minimized in this embodiment.

After the target parallelism is determined, the distance between semiconductor laser 4 and collimating lens 9 is adjusted, similar to the first embodiment, so that the target parallelism is obtained. The same autocollimator 21 as in the first embodiment, which is configured such that the light beam is concentrated most intensively at predetermined focal point F1 when a parallel light beam is incident thereon, may be used. The position, for example, of semiconductor laser 4 is moved in direction Z of the optical axis while the light beam that has passed through collimating lens 9 is incident on autocollimator 21, in order to obtain the target spot size and the target beam state.

Although the target parallelism may be set each time according to the spherical aberration of objective lens 13, the adjustment can also be carried out, when this embodiment is applied to a mass-production process, by dividing objective lenses into some groups according to the spherical aberration; by determining, in advance, a target parallelism for each group; and by applying the target parallelism.

Although each optical element is adjusted and fixed such that the spherical aberration is optimized by using the above-mentioned method, the element may be shifted from the adjusted optimum position due to heat treatment or the like performed after fixation. In this case, the shift can be corrected by liquid crystal element 10. As described above, when the spherical aberration is large, a phase shift within each divided subsection of liquid crystal element 10 is not negligible. However, according to the present invention, an effective correction can be made by minimal driving of the liquid crystal element because the spherical aberration is sufficiently limited. Although substantial driving of the liquid crystal element causes the problem of degradation in the shift characteristics of the objective lens, an optical head that is adjusted according to the present invention can avoid such a problem.

As will be apparent from the description mentioned above, elements other than semiconductor laser 4 may be moved in direction Z of the optical axis because the spot size can be adjusted by changing the distance between semiconductor laser 4 and collimating lens 9. For example, collimating lens 9 may be moved in direction Z of the optical axis of a light beam. When collimating lens 9 that is to be moved is housed in lens holder 17, lens holder 17 may preferably be moved in direction Z of the optical axis. In another embodiment, it is also possible to move semiconductor laser 3 instead of semiconductor laser 4.

Furthermore, other optical elements provided on the optical path between semiconductor laser 4 and collimating lens 9, such as dichroic prism 7 and polarization beam splitter 8, may be moved in direction Z of the optical axis of the light beam.

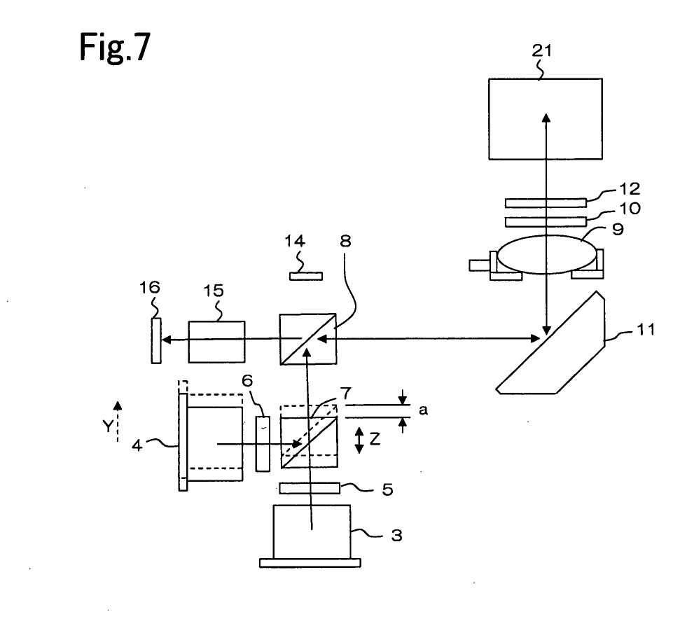

FIG. 7 shows an embodiment in which the distance between semiconductor laser 4 and collimating lens 9 is changed by moving dichroic prism 7. In this embodiment, semiconductor laser 4 or a holder thereof only can move in direction Y by being pressed against a side wall of the housing (see the broken line in the figure). Assuming such an arrangement, a shift of dichroic prism 7 to the position shown by the broken line in direction Z of the optical axis shifts the optimum position of semiconductor laser 4 with regard to direction Y. Therefore, semiconductor laser 4 is adjusted by being moved in direction Y such that the optical axis of the light beam emitted from collimating lens 9 is perpendicular to the recording medium. As a result, the distance between collimating lens 9 and semiconductor laser 4 is changed by distance a, and the spherical aberration can be controlled.

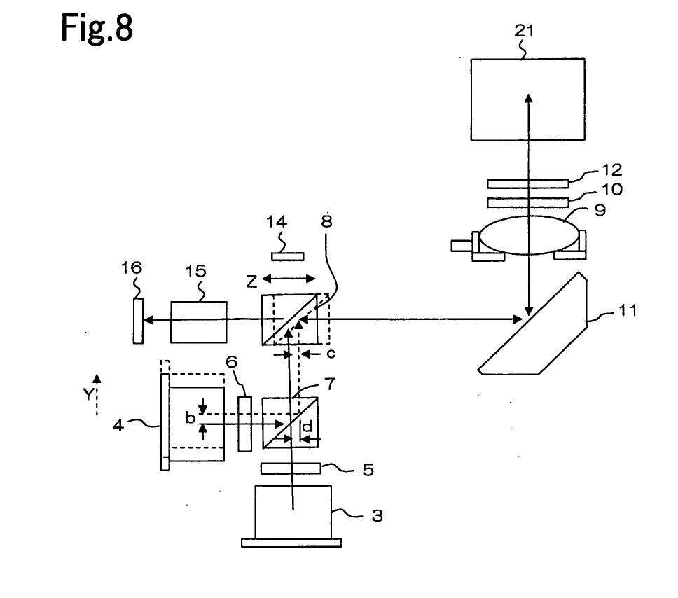

FIG. 8 shows an embodiment in which the distance between semiconductor laser 4 and collimating lens 9 is changed by moving beam splitter 8. According to this embodiment, the semiconductor laser or a holder thereof only can move in direction Y by being pressed against a side wall of the housing (see the broken line in the figure). Assuming such an arrangement, a shift of beam splitter 8 to the position shown by the broken line in direction Z of the optical axis shifts the optimum position of semiconductor laser 4 with regard to direction Y. Therefore, semiconductor laser 4 is adjusted by being moved in direction Y such that the optical axis of the light beam emitted from collimating lens 9 is perpendicular to the recording medium. The distance between collimating lens 9 and semiconductor laser 4 is decreased by distance b and distance c, and is increased by distance d. Since distance c is equal to distance d, the distance between semiconductor laser 4 and collimating lens 9 is decreased by distance b, and spherical aberration can be controlled.

Although certain preferred embodiments of the present invention have been shown and described in detail, it should be understood that various changes and modifications may be made without departing from the spirit or scope of the appended claims.

What is claimed is:

1. A method for manufacturing an optical head having a laser beam emitting device that emits a light beam of a predetermined wavelength, an objective lens that focuses the light beam on an optical recording medium and a parallelism adjusting lens that is disposed on an optical path between the laser beam emitting device and the objective lens, wherein the parallelism adjusting lens is configured to change parallelism of the laser beam, comprising the step of:
adjusting the parallelism of the light beam that has passed through the parallelism adjusting lens by adjusting a distance between the laser beam emitting device and the parallelism adjusting lens while causing the laser beam emitting device to emit the light beam and causing the light beam to pass through the parallelism adjusting lens.

2. The method according to claim 1, wherein the step of adjusting the parallelism of the laser beam includes detecting the parallelism by causing the light beam that has passed through the parallelism adjusting lens to be incident on a measurement means, the measurement means being configured such that the light beam is concentrated most intensively at a predetermined point when the light beam incident on the measurement means is a parallel beam, and detecting the parallelism by measuring a spot size of the light beam at the predetermined point.

3. The method according to claim 1, further comprising:
measuring spherical aberration of the objective lens; and
determining a target parallelism of the light beam that has passed through the parallelism adjusting lens, based on the spherical aberration of the objective lens, wherein the target parallelism is determined such that spherical aberration in an optical system between the laser beam emitting device and the objective lens is minimized,
wherein the step of adjusting the parallelism of the laser beam includes adjusting a distance between the laser beam emitting device and the parallelism adjusting lens in order to obtain the target parallelism.

4. The method according to claim 1, further comprising:
measuring spherical aberration of the objective lens; and
determining a target parallelism of the light beam that has passed through the parallelism adjusting lens, based on the spherical aberration of the objective lens, wherein the target parallelism is determined such that spherical aberration in an optical system between the laser beam emitting device and the objective lens is minimized,
wherein the step of determining the target parallelism includes determining a target spot size and a target beam state of the light beam at a predetermined point, wherein the light beam has passed through the parallelism adjusting lens and is incident on a measurement means, wherein the measurement means is configured such that the light beam is concentrated most intensively at the predetermined point when the light beam incident on the measurement means is a parallel beam and is in a target beam state, wherein the target beam state is either a convergent beam or a divergent beam, and
wherein the step of adjusting the parallelism of the laser beam includes adjusting a distance between the laser beam emitting device and the parallelism adjusting lens while causing the light beam that has passed through the parallelism adjusting lens to be incident on the measuring means, in order to obtain the target spot size and the target beam state.

5. The method according to claim 1, wherein adjusting the distance includes moving the laser beam emitting device in a direction of an optical axis of the light beam.

6. The method according to claim 1, wherein adjusting the distance includes moving the parallelism adjusting lens in a direction of an optical axis of the light beam.

7. The method according to claim 1, wherein adjusting the distance includes moving an optical element provided on an optical path between the laser beam emitting device and the parallelism adjusting lens in a direction of an optical axis of the light beam.
